(19) United States
(12) Patent Application Publication
(10) Pub. No.: US 2021/0046517 A1
(43) Pub. Date: Feb. 18, 2021

(54) CLEANER DEVICES FOR ELEVATOR PADDLES

(71) Applicant: DEERE & COMPANY, MOLINE, IL (US)

(72) Inventors: ROMULO T. TOLEDO, Tres de Maio (BR); MARCELO MAHLER, HORIZONTINA (BR); JULIANO SIMOES, HORIZONTINAL (BR); ADILSON HECK, ORIZONTINA (BR); ANDERSON POZZEBON BORGES, HORIZONTINA (BR); CLEBER A. PEDO, HORIZONTINA (BR)

(21) Appl. No.: 16/947,702

(22) Filed: Aug. 13, 2020

(30) Foreign Application Priority Data
Aug. 15, 2019 (BR) 1020190169850

(51) Int. Cl. B08B 1/00; A01D 61/00

(52) U.S. Cl. CPC B08B 1/008; B08B 1/002; A01D 61/00

(57) ABSTRACT

This disclosure provides a lifting system for a grain combine. The grain combine includes a plurality of paddles connected transversely to a chain. Each paddle includes an inner edge attached to the chain and an outer edge. The chain is driven by two toothed pulleys. The system also includes a housing with a lower feed opening and an upper discharge opening. The lifting system includes at least one paddle having a cleaning element attached to its outer edge. The cleaning element is adapted to contact at least part of the inner surface of the lifting system housing in which part of the surface has perforations.

### RELATED APPLICATIONS

This claims priority to Brazilian Application No. 1020190169850, Cleaner Devices for Elevator Paddles, filed Aug. 15, 2019, which is hereby incorporated by reference in its entirety.

### FIELD OF THE DISCLOSURE

The present disclosure relates generally to grain combines. More specifically, this disclosure relates to a grain combine lifting system that provides more effective grain cleaning while promoting its lifting.

### BACKGROUND OF THE DISCLOSURE

Various models of grain combines are known in the prior art. This disclosure relates to the type of lifting system for a grain combine as illustrated in FIG. 1.

FIG. 1 illustrates a grain lifting system 2,9 for a grain combine, as known from the state of the art. FIG. 1A illustrates a perforated plate 3 used as a cover 3 for the lifting system 2,9 of the grain lifting system shown in FIG. 1.

It is noted that the system illustrated comprises a lifting system 2 for clean grain and a lifting system 9 for rethreshing (used to redirect to the threshing system and separate unthreshed grain).

FIG. 2 illustrates the internal components of the grain lifting system 2,9, as adopted by the grain lifting system in FIG. 1. As illustrated, in general, the system comprises a plurality of paddles 4 connected to a chain 5, where the chain 5 is moved by two toothed pulleys (sprockets) 6.

In addition, the system comprises a housing with a lower feed opening and an upper discharge opening. In the lower portion, the system comprises a curved perforated plate 3, called an elevator (following the movement of the paddles 4).

The perforated plate 3 serves to assist in cleaning the grain, allowing tailings (unwanted materials harvested together with the grain) to be dispensed through the openings.

In various situations, the openings in the perforated plate 3 may become totally or partially clogged due to the accumulation of dirt, which makes it difficult to remove the tailings and causes more tailings to be lifted together with the grain; this should preferably be avoided.

The current state of the art, however, has no known solution to assist in this specific problem. Thus, it is necessary to develop a component that assists in clearing the openings in these perforated plates used in the lower portion of grain lifting systems 2,9 used in the grain combine 1.

As will be better detailed below, this disclosure aims to solve the above-described problems of the prior art in a practical and efficient way.

### SUMMARY OF THE DISCLOSURE

This disclosure aims to provide a grain lifting system that makes use of an element to assist in the elimination of tailings, affecting the cleaning and quality of the grain. Such an disclosure significantly slows the clogging of the holes in the perforated plates used as doors in the lower portion of the FIG. 1 rethreshing and clean grain elevators.

In order to achieve the objectives described above, this disclosure provides a grain lifting system for a grain combine comprising a plurality of paddles connected transversely to a chain, where each paddle comprises an inner edge attached to the chain and an outer edge, with the chain driven by two toothed pulleys. The system further comprises a housing with a lower feed opening and an upper discharge opening, in which the lifting system comprises at least one paddle with a cleaning element attached to its outer edge, where the cleaning element is adapted to contact the perforated plate, acting to remove the tailings.

### BRIEF DESCRIPTION OF THE DRAWINGS

The detailed description presented below refers to the attached figures and their respective reference numbers.

FIG. 1 illustrates a lifting system for a grain combine.

FIG. 1A illustrates a perforated plate used as a cover for the grain combine lifting system illustrated in FIG. 1.

FIG. 2 illustrates the internal elements of the grain lifting system, as adopted by the grain combine in FIG. 1.

FIG. 2A illustrates details as shown in FIG. 2.

FIG. 3 illustrates a schematic cross-sectional view of a grain lifting system paddle, which has a brush installed for cleaning and acting on the perforated plate for the clean grain lifters and cleaning.

### DETAILED DESCRIPTION OF THE DRAWINGS

As a preliminary matter, it is emphasized that the description below will start from a preferred embodiment of the disclosure. As will be apparent to any person skilled in the art, however, the disclosure is not limited to that particular embodiment.

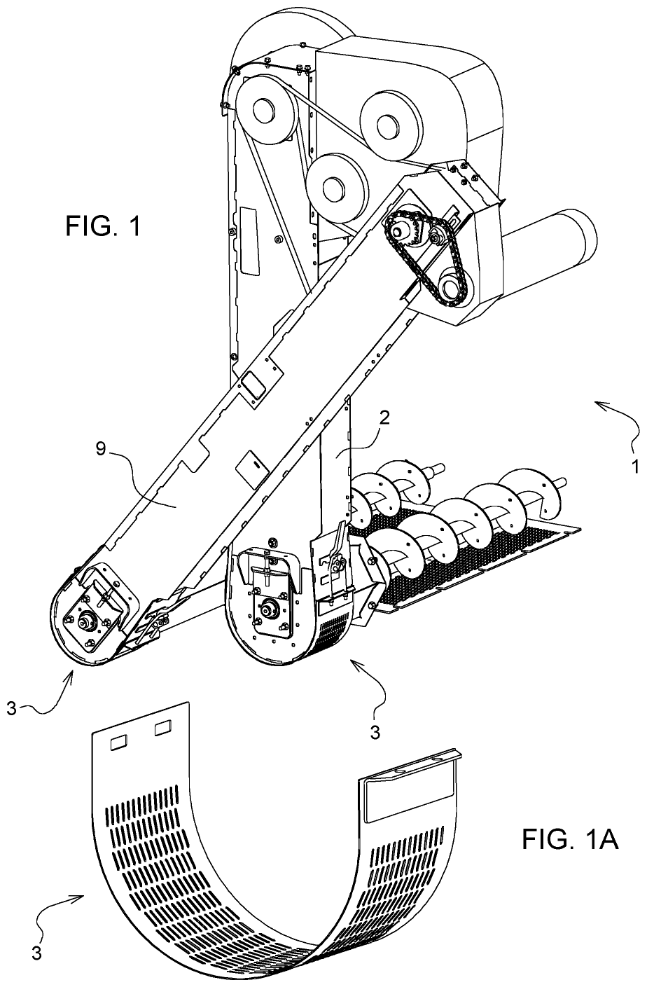

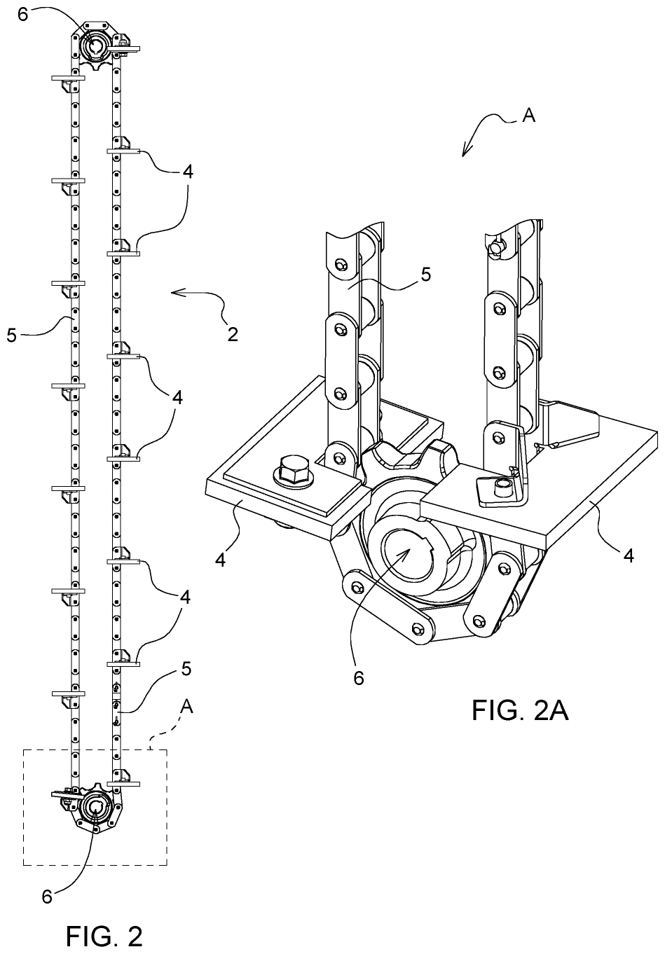

As previously mentioned, the disclosure described here proposes an improvement to the grain lifting systems used in grain combines, as illustrated in FIGS. 1, 1A, 2, and 2A presented in the previous section.

It is noted that the system illustrated comprises a lifting system 2 for clean grain and a lifting system 9 for rethreshing (used to move the tailings), in which these lifting systems 2,9 comprise a plurality of paddles 4 connected to a chain 5, where chain 5 is moved by two toothed pulleys 6.

In addition, the system comprises a housing with a lower feed opening and an upper discharge opening. In the lower portion, the system comprises a curved perforated plate 3 (following the movement of the paddles 4).

During operation of the illustrated system, the harvested grain is deposited in the lower portion of the grain lifting system 2 through the feed opening, and the paddles 4, when moving, carry this grain to the upper part of the lifting system 2, where it is discharged through the discharge opening.

In the preferred configurations, each paddle 4 in the lifting system 2,9 comprises an inner edge attached to the chain 5 such that the paddle 4 is positioned transverse to the chain 5. Thus, in the lower and upper portion of the lifting system 2,9, the paddles 4 make a translational movement following the movement of the toothed pulleys (sprockets) 6, in which the outer edge of each paddle 4 closely follows the inner walls of the lifting system 2 housing.

Thus, the curved shape of the lower perforated plate 3 corresponds substantially to the profile of the movement of the outer edge of each paddle 4 in lifting system 2.

Additionally, perforated plate 3 serves to assist in the cleaning of the grain, allowing the tailings (unwanted materials harvested together with the grain) to be dispensed through the holes. However, in different situations, the holes in perforated plate 3 are totally or partially blocked due to the accumulation of dirt, which makes it difficult to clean the grain and causing more tailings to be lifted together with the grain, which should preferably be avoided.

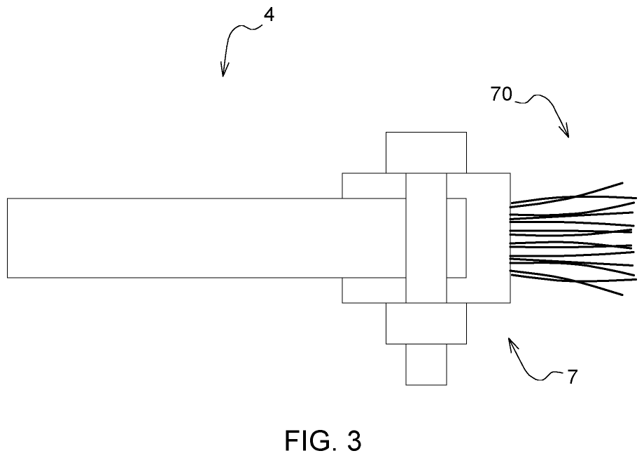

In order to prevent the above-mentioned problem, the disclosure provides a lifting system 2,9 for a grain combine 1 comprising at least one paddle 4, as illustrated in FIG. 3.

According to the optional configuration, lifting system 2,9 comprises at least one paddle 4, which in turn comprises a cleaning element 7 fixed on its outer edge, where cleaning element 7 is adapted to contact at least part of the inner surface of the lifting system 2 housing and/or the perforated plate 3. Preferably, the cleaning element 7 adopted is a brush with bristles 70 positioned transverse to the chain 5.

It should be noted here that the preferred position of the bristles 70 would be perpendicular to the chain 5. However, due to the difficulty in reaching such an angle with precision, variations in this position are tolerated, so that any transverse position of the bristles 70 would be within the scope of the disclosure.

In addition, other variations of the cleaning elements can be adopted, such as sponges or any other element that promotes the scraping of dirt deposited primarily on the perforated plate 3 in the lower portion of the lifting system 2 housing described above.

Thus, more broadly, this disclosure provides a grain combine 1 comprising at least one lifting system 2,9. The lifting system 2,9 comprises a plurality of paddles 4 connected transversely to a chain 5. Each paddle 4 comprises an inner edge attached to the chain 5 and an outer edge The chain 5 is moved by two toothed pulleys 6. The system further comprises a housing with a lower feed opening and an upper discharge opening. In an innovative way, the disclosure provides that the lifting system 2,9 comprises at least one paddle 4 comprising a cleaning element 7 attached to its outer edge.

The number of paddles 4 including cleaning elements may vary according to each configuration, in which only one paddle 4, some paddles 4, or all paddles 4 may be included in such an element.

Therefore, according to the disclosure described so far, the cleaning element 7 assists in cleaning all the inner walls of the housing of the lifting system 2,9, especially in cleaning the lower perforated plate 3. Thus, when paddle 4 having the cleaning element 7 moves across the perforated plate 3, the cleaning element 7 will make a sweeping movement over the perforated plate 3, preventing dirt from accumulating in this location so as to decrease the likelihood of the holes in the perforated plate 3 to get clogged.

When the cleaning element 7 includes bristles 70, the degree of stiffness of the bristles 70 may vary, so that each technician can determine the ideal stiffness for each application.

Regarding the attachment of the cleaning element 7 on the paddle 4, several means are provided for making such attachment. Among these possibilities, the disclosure provides that the cleaning element 7 may be attached to each paddle 4 by means of screws, a compression fit, glue or any other known attachment method.

From the above, it is clear that the described disclosure that is proposed solves the problems of the state of the art, since the cleaning element 7 helps remove tailings collected together with the grain inside the lifting system 2,9 in a simple and effective way.

It is important to point out that, as will be clear to any technician familiar with the subject, the proposed system can be applied to any grain combine 1 lifting system, such as a clean grain lifting system 2 and/or a rethreshing lifting system 9.

Numerous variations affecting the scope of protection of this application are permitted. Thus, the fact that this disclosure is not limited to the particular configurations/embodiments described above is stressed.

What is claimed is:

1. Lifting system for a grain combine, comprising:
a plurality of paddles connected transversely to a chain, wherein each paddle comprises an inner edge attached to the chain and an outer edge, the chain is driven by two toothed pulleys;
a housing with a lower feed opening and an upper discharge opening, wherein at least one paddle comprises a cleaning element attached to the outer edge of the paddle, and the cleaning element is adapted to contact at least part of the inner surface of the lifting system housing.

2. The lifting system according to claim 1, comprising a curved perforated plate in the lower portion of the housing, wherein the cleaning element is adapted to contact at least a portion of the inner surface of the perforated plate.

3. The lifting system according to claim 1, wherein the cleaning element comprises a brush with bristles, and the bristles are positioned transversely with respect to the chain.

4. The lifting system according to claim 2, wherein the cleaning element comprises a brush with bristles, and the bristles are positioned transversely with respect to the chain

5. The lifting system according to claim 1, wherein the cleaning element is attached to each paddle by at least one of screws, compression fitting, or glue.

6. The lifting system according to claim 2, wherein the cleaning element is attached to each paddle by at least one of screws, compression fitting, or glue.

7. The lifting system according to claim 3, wherein the cleaning element is attached to each paddle by at least one of screws, compression fitting, or glue.

8. The lifting system according to claim 4, wherein the cleaning element is attached to each paddle by at least one of screws, compression fitting, or glue.
